(19) United States
(12) Patent Application Publication
(10) Pub. No.: US 2004/0042407 A1
(43) Pub. Date: Mar. 4, 2004

(54) Method for checking the compliance of a bluetooth device for testing

(76) Inventors: Hasan Karacelik, Dortmund (DE); Roland Masing, Borken (DE); Stefan Nieder, Isselburg (DE)

Correspondence Address: BELL, BOYD & LLOYD, LLC, P. O. BOX 1135, CHICAGO, IL, 60690-1135, US

(21) Appl. No.: 10/380,747

(22) PCT Filed: Aug. 31, 2001
(86) PCT No.: PCT/DE01/03342

(30) Foreign Application Priority Data
Sep. 13, 2000 (DE) 100452434

(51) Int. Cl. H04L 1/00

(52) U.S. Cl. 370/241; 370/469

(57) ABSTRACT

A method is provided for checking the compliance of a Bluetooth device for testing, wherein the interface for the Logic Link Control and Adaptation Protocol (L2CAP) with higher layers of the Bluetooth protocol stack is tested, with the L2CAP being placed in a test mode via a Bluetooth message such that messages for higher layers are diverted to a test device.

### BACKGROUND OF THE INVENTION

The present invention relates to a method for checking compliance of a Bluetooth device for testing in which the interface for the “Logic Link Control and Adaption Protocol” (L2CAP) to higher layers of the Bluetooth protocol stack is tested, in that the L2CAP is placed in a test mode, such that messages for higher layers are diverted to a test device. The present invention also relates to a system for checking compliance of a Bluetooth device in which the interface of the L2CAP to higher layers of the Bluetooth protocol stack is tested, in that the L2CAP is placed in a test mode, with a Bluetooth device to be tested and a test device, with messages for higher layers being diverted to a test device in the test mode.

Devices that operate according to the Bluetooth standard must undergo a compliance test (“Bluetooth Compliance Test”) before their market launch. The Bluetooth standard is defined in “BLUETOOTH SPECIFICATION Version 1.0 B”. The Bluetooth Compliance Test is designed to make sure that the devices are capable of faultless communication with other Bluetooth products. For one part of this test, the fault-free implementation of the “Logic Link Control and Adaptation Protocol” (L2CAP) is tested. The protocols involved in a Bluetooth communication have a layer structure, so that they collectively form a Bluetooth protocol stack. For the compliance test for the L2CAP, the interface of the L2CAP to higher layers of the Bluetooth protocol stack is checked using a test device. To enable this, the L2CAP must be placed in a test mode. In this test mode, the messages meant for higher layers of the Bluetooth protocol stack are diverted so that instead of being sent to the higher layers of the Bluetooth protocol stack they are sent to the test device. The test device is then able to verify correct implementation of the L2CAP.

It is, in principle, open to the manufacturers when performing the compliance test to decide how the Bluetooth device (“Device Under Test” (DUT)) is placed in the LSCAP test mode. There are many solutions for realizing the setting of this test mode. For example, the test mode can be realized by a suitable configuration of the hardware, in that, for example, switches, jumpers, connectors or similar components are used. It is also conceivable to realize the test mode by a suitable input via a user interface. These solutions are problematic. A hardware solution is expensive because, in this case, all the devices must have the special hardware components. A solution by making an input via the user interface firstly presumes the existence of such an interface. Furthermore, it would be necessary to prevent unintentional entry into the test mode, which also brings with it unwanted expense.

An object of the present invention is, therefore, to enable the transition to a test mode for the LSCAP whereby the expense necessary for this is minimized.

### SUMMARY OF THE INVENTION

The present invention is based on the method in accordance with the generic type, in that the L2CAP is placed in the test mode by a Bluetooth message. In this way, layers above the L2CAP including a user interface can be dispensed with. Additional hardware components are also superfluous. Furthermore, on the basis of the present invention, the message for the test device can be sent from any Bluetooth device that can generate such a message.

Preferably, an “Asynchronous Connectionless” message (ACL message) is set up between a second Bluetooth device and the Bluetooth device to be tested, and the Bluetooth message is sent via the ACL connection. An ACL connection enables a packet data exchange between two Bluetooth devices. In addition to ACL connections, “Synchronous Connection-Oriented” connections (SCO connections) are also known. Because the L2CAP specification is defined for only ACL connections and no support for SCO connections is planned, the setting up of an ACL connection for transmitting the test message is suitable.

Preferably, the ACL connection is again cleared down after the message has been sent and the L2CAP remains in the test mode. Accordingly, the Bluetooth device to be tested can be tested in any way by the test device in an advantageous manner independent of the ACL connection between the Bluetooth devices.

It is particularly advantageous if the test mode is terminated by sending a further message. The device and the test can, thus, be switched between the test mode and the normal operating mode without completely resetting its functions.

In this connection it is particularly advantageous if the further message is a Bluetooth message. The switch off of the test mode and the transition to the normal operating mode can then be carried out from the same Bluetooth device used to set the test mode beforehand.

It can be advantageous if the message is a special L2CAP message. A message of this kind with a special structure, therefore, would be used exclusively to place the device under test in the test mode, which would prevent the Bluetooth device to be tested being unintentionally placed in the test mode.

It also can, however, be advantageous if the message is part of a Connection Request Packet of the L2CAP. The Connection Request Packets are transmitted to generate a channel between two Bluetooth devices. Therefore, a connection request packet is particularly suitable for attaching the message to set up the test mode.

It is particularly advantageous if the message is achieved by a free Protocol/Service Multiplexer value (PSM value) of a Connection Request Packet. In addition to the data field for the source channel identification, the PSM data field is also a component of the Connection Request Packet and is thus suitable for carrying the message that effects the change to the test mode.

The present invention is based on the system in accordance with the generic type in that a second Bluetooth device is used to send the Bluetooth message and to place the L2CAP in the test mode. In this way, layers above the L2CAP including a user interface are superfluous. Additional hardware components also are not required. Furthermore, the message for the test device can be sent from any Bluetooth device that has the capability of generating such a message.

It is preferred for the message to be a special L2CAP message. A message of this kind with a special structure would be used exclusively to place the test device in the test mode, which would prevent the Bluetooth device to be tested being inadvertently placed in the test mode.

Of course, it also can be useful if the message is part of a Connection Request Packet of the L2CAP.

It is particularly preferable if the message is realized by a free PSM value of a Connection Request Packet. Connection Request Packets are sent to generate a channel between two Bluetooth devices. To this extent, a Connection Request Packet is particularly suitable for carrying the message to set up the test mode.

The present invention is based on the surprising knowledge that a test mode for a L2CAP Compliance Test can be established without influencing the device hardware and without using the user interface. Because a Bluetooth message is used to place the device to be tested in the test mode, the expense for testing the L2CAP is minimized.

Additional features and advantages of the present invention are described in, and will be apparent from, the following Detailed Description of the Invention and the Figures.

### BRIEF DESCRIPTION OF THE FIGURES

FIG. 1 shows a schematic of a configuration for performing the method in accordance with the present invention.

### DETAILED DESCRIPTION OF THE INVENTION

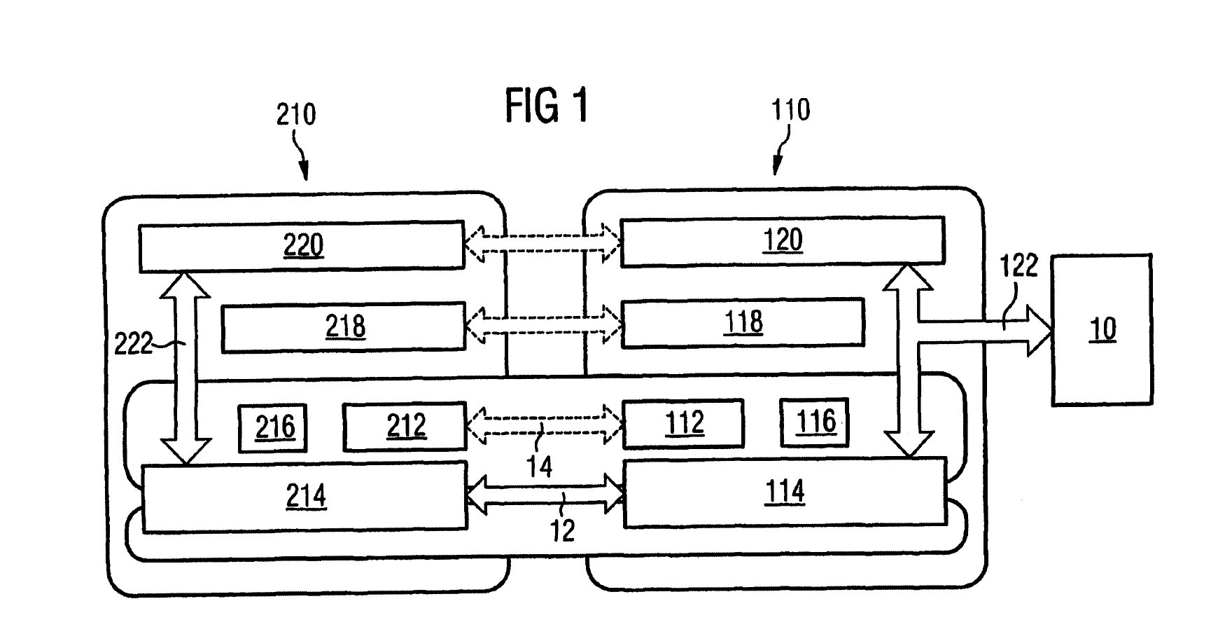

FIG. 1 shows a schematic of a system for performing the method in accordance with the present invention. Two Bluetooth devices 110, 210 with their Bluetooth protocol stacks are shown. The Bluetooth device 110 is a Bluetooth device under test (DUT). The Bluetooth device 210 is any Bluetooth device that is capable of communicating with the Bluetooth device under test 110. The construction of the Bluetooth protocol stack of the Bluetooth device under test 110 is shown in the following. As the lowest layer, the Bluetooth protocol stack has a baseband 114. Above the baseband is the Link Control and Adaption Protocol (L2CAP) 112. The Link Manager Protocol (LMP) 116 is arranged above the baseband 114 as a further protocol. The Link Manager Protocol 116 is used to establish and control the connection. The network layer 118 is above the L2CAP 112 and LMP 116 layers. Protocols of higher layers or applications 120 are, in turn, located above this network layer 118.

The Bluetooth device 210 is constructed in the same manner; i.e., with the baseband 214, L2CAP 212 and LMP 216, network layer 218, protocols of higher layers or applications 220 layer sequence. In the communication between the Bluetooth devices 110 and 210, the physical communication takes place between the baseband 114 of the Bluetooth device 110 and the baseband 214 of Bluetooth device 210. A data link 14 exists between the L2CAP 112 of the Bluetooth device 110 and the L2CAP 212 of the Bluetooth device 210.

Communication within the particular Bluetooth devices 110 and 210 takes place between the protocol levels with protocols L2CAP 112 and LMP 116 or between L2CAP 212 and LMP 216 and the higher layers, as is illustrated by the transmission paths 122 and 222 respectively.

If the Bluetooth device 110 is to be tested, a test device 10 is used for this purpose. A Bluetooth message is sent to the Bluetooth device under test 110 from Bluetooth device 210 or from any other Bluetooth device with the appropriate capability. The Bluetooth device 110, or the L2CAP 112 is placed in the test mode by this Bluetooth message, so that the communication between the L2CAP 112 and higher layers is diverted to the test device 10. The Bluetooth message from the Bluetooth device 210 is transmitted in such a way that an ACL connection is established and the Bluetooth message is sent via the ACL connection. After the message has been sent, the ACL connection again can be cleared down with, of course, the L2CAP 112 of the Bluetooth device 110 under test remaining in the test mode and remaining capable of communicating with the test device 10. The test mode is not switched back to a normal operating mode until a suitable Bluetooth message is again sent from the Bluetooth device 210 or from any other Bluetooth device.

The Bluetooth message can be designed such that a special L2CAP signal command is provided for it, whereby a standardization would have had to have been carried out for that purpose. A type of transmission of the Bluetooth message without such a standardization is possible if the message is “concealed” in a different standardized command. This could, for example, be a Connection Request Packet of the L2CAP, with the message being realized in this case by a free PSM (Protocol/Service Multiplexer) value.

Although the present invention has been described with reference to specific embodiments, those of skill in the art will recognize that changes may be made thereto without departing from the spirit and scope of the present invention as set forth in the hereafter appended claims.

1. Method for checking the compliance of a Bluetooth device under test (110) whereby the interface of the Logic Link Control and Adaption Protocol (L2CAP) (112) to higher layers of the Bluetooth protocol stack is tested, in that the L2CAP (112) is placed in a test mode, so that messages for higher layers are diverted to a test device (10),
characterized in that,
the L2CAP (112) is placed in the test mode by a Bluetooth message.

2. Method in accordance with claim 1,
characterized in that,
an ACL connection is set up between a second Bluetooth device (210) and the Bluetooth device (110) under test and
the Bluetooth message is sent via the ACL connection.

3. Method in accordance with claim 1 or 2,
characterized in that,
the ACL connection is again cleared down after sending the message and
the L2CAP (112) remains in the test mode.

4. Method in accordance with one of the preceding claims,
characterized in that,
the test mode is terminated by sending a further message.

5. Method in accordance with one of the preceding claims,
characterized in that,
the further message is a Bluetooth message.
